(19) United States
(12) Patent Application Publication
(10) Pub. No.: US 2018/0204411 A1
(43) Pub. Date: Jul. 19, 2018

(54) DUAL GAMING ELEMENT SYSTEM AND METHOD

(71) Applicants: Stanley Deck, Las Vegas, NV (US); Brooke Dunn, Henderson, NV (US)

(72) Inventors: Stanley Deck, Las Vegas, NV (US); Brooke Dunn, Henderson, NV (US)

(21) Appl. No.: 15/407,261

(22) Filed: Jan. 17, 2017

(51) Int. Cl. G07F 17/32

(52) U.S. Cl. CPC G07F 17/3211; G07F 17/3244; G07F 17/3216; G07F 17/3227

(57) ABSTRACT

A system enables a wagering method on an underlying wagering event including a processor, memory, player input controls, value-in-value-out system, a visual display area enclosing at least two gaming outcome elements each of which is capable of providing at least two distinct random outcomes. The system has a mechanical system physically reorienting the at least two gaming outcome elements and a sensing system capable of determining final reoriented outcomes on the at least two gaming outcome elements. The processor receives wagers on specific random outcome events provided by the at least two gaming outcome elements compare final reoriented outcomes with the specific random outcome events on which a received wager is based. The at least two gaming outcome elements have equal probability of different outcomes on at least two surfaces and the received wager identifies distinct random outcome events for each of the at least two gaming outcome events.

### BACKGROUND OF THE INVENTION

### 1. Field of the Invention

The present invention relates to gaming technology, particularly gaming apparatus and methods using physical gaming apparatus with multiple, independent gamin g elements.

### 2. Background of the Art

There are numerous games (without wagering) and gaming technology (with wagers) that use physical objects that assist in the provision of random event outcomes that are used to assist in game play or gaming outcomes. Among the games in which physical gaming objects such as dice, balls, wheels with pointers and the like are Craps, Yahtzee, roulette, Monopoly® game, Parcheesi, Bar dice, Pachinko, and the like. It is even common practice to make decisions based on random events from disks or coins (e.g., heads-or-tails).

There have been limited advances in some of these games over the years, In gaming environments, the most significant advances in dice and roulette games have been the conversion of the games to electronic formats, converting wagering to an electronic format automation of play, and adding bonus wagers (such as streak (wagers to the underlying game.

Examples of electronic wagering systems at gaming tables (e.g., roulette and dice games) include at least U.S. Pat. Nos. 6,659,866; 6,733,388; and 8,474,820; and Published U.S. Patent Application Documents Nos. 20130184044; 20040116177; and 20110065513.

Other technologies used to try and vary wagering systems, including roulette and dice games include U.S. Pat. No. 5,634,639 (Tokito) which discloses a ball game apparatus that has a plurality of balls, a spiral rail for automatically delivering the balls, a field portion on which the balls delivered by the spiral rail can roll with a given degree of freedom, winning pocket portions and invalid pockets formed over the field portion for receiving a plurality of the balls in each of them, a CCD camera for counting the number of balls received in the winning pocket portions and a calculator for calculating a score from the number of balls counted by the CCD camera.

U.S. Pat. No. 6,120,023 (Lai) describes a random access game toy, which includes a rod member, which has a plurality of longitudinal grooves and longitudinal number bars alternatively arranged around the periphery of a top end thereof, transparent container covered on the top end of the rod member, and a set of first color balls of a first color and at least one second color ball of a second color received in the transparent container, wherein the color balls fall to the longitudinal grooves to indicate a respective number at the number bars when the rod member is held in vertical, and are received in the transparent container outside the rod member when the rod member is turned upside down.

Published US Patent Application NO. 20160129341 (Sahl et al.) evidences a game object that is used as a moving object to provide a random outcome event by movement and final stoppage in an outcome indicating position or mode.

Examples are die, dice, balls, roulette balls, roulette wheels and pointers on a candy wheel. The object has: A) a game object body; B) the game object body containing an accelerometer microchip or a receiver in communication with a transmitter, power source and light-emitting elements within the game object body, light from the light-emitting body being visible outside the game object body; and C) the microchip closing an electronic circuit for a period of time less than 5 minutes after the game body is moved.

Alternative gaming apparatus and methods are desired that are easily learned and are entertaining are desired.

### SUMMARY OF THE INVENTION

A system enables a wagering method on an underlying wagering event including a processor, memory, player input controls, value-in-value-out system, a visual display area enclosing at least two gaming outcome elements each of which is capable of providing at least two distinct random outcomes. The system has a mechanical system physically reorienting the at least two gaming outcome elements and a sensing system capable of determining final reoriented outcomes on the at least two gaming outcome elements. The processor receives wagers on specific random outcome events provided by the at least two gaming outcome elements compare final reoriented outcomes with the specific random outcome events on which a received wager is based. The at least two gaming outcome elements have equal probability of different outcomes on at least two surfaces and the received wager identifies distinct random outcome events for each of the at least two gaming outcome events.

### BRIEF DESCRIPTION OF THE FIGURES

FIG. 1A shows a single player position gaming apparatus enabling practice of the present technology.

FIG. 1B shows another schematic for an electronic system for enabling play of the gaming method described herein.

FIG. 1C shows another schematic for a multiplayer position banked electronic system for enabling play of the gaming method described herein.

### DETAILED DESCRIPTION OF THE INVENTION

A method of executing a wagering event may be performed on an electronic gaming apparatus including a housing, a processor, memory, a display area for providing wagering event outcomes with gaming outcome elements, player input controls, and value-in-value-out components. The method includes:

providing at least two visually different gaming outcome elements within a confined area in a gaming apparatus;
the processor accepting a wager on an underlying gaming event executed on the electronic gaming apparatus based on random event outcomes using the gaming outcome elements;
physically randomizing orientation of the at least two gaming outcome elements to provide two distinct wagering event outcomes, one each on each of the at lest two gaming outcome elements;
the processor receiving information on the actual orientation of the at least two gaming outcome elements which provides two distinct wagering event outcomes. The processor resolves the wager on the underlying gaming event as follows;
a) the wager on the underlying gaming event is based on correspondence on predicted gaming event outcomes on each of the at least two gaming outcome elements with the received information of the actual orientation of the at least two gaming outcome elements; and
b) winning outcomes are determined based on correspondence on event outcomes having probabilities no greater than 1:2.

The wagering event includes a single wager directed at the at least two outcomes from the at least two gaming outcome elements. The wager must identify the individual outcomes for each of the two gaming outcome elements. For example, if the two gaming outcome elements were coins, the wager must be based on an expectation, prediction or directed wager on any event selected from the group consisting of two heads (one on each coin), two tails (one on each coin), one heads and one tails (from any combination of the two coins) and one heads and one tails with the specific contributing coins for each outcome identified. In the latter case, the individual coins/tokens may be distinguished as left/right (each in separate chambers), gold/silver, first color/second color, or any other visually distinguishable differentiation between the at least to gaming outcome elements. With dice, the same distinctions may be made using size, color, position or combinations of different visual effects to distinguish between the individual die as unique gaming outcome elements. The die may be at least three-side die such as one with elongated elements with a triangle cross-section and different outcomes (e.g., numbers) on each face. These are historically known as stick die. They may also be four-sided, although a four-sided pyramid may work as a die. Typically, a six-sided die may be used for each gaming outcome element. The die may have the classic 6 different pips or numbers on each face, may have two single numbers, with three of each number on individual faces, or may have three single numbers with two of each number on individual faces. As the die cubes are equal and symmetrically oriented, the probability of each face being an outcome is the same.

Different gaming events may be created by altering number probabilities such as by having the die (using 1, 2 and 3 as outcomes) have three faces with a 1, two faces with a 2, and one face with a 3. In this way, the statistical odds on any number will differ, so the payout awards would differ on wagers predicting two “1”s, two “2” s, two “3” s, generally a 1 and a 2, generally a 1 and 3, generally a 2 and a 3, and specific dice with specific number outcomes (e.g., left die is a 2 and right die is a 1).

The method may be practiced wherein the at least two gaming outcome elements may be physical elements with at least two surfaces having equal opportunities for gaming event outcomes. The at least two gaming outcome elements may be physical elements that are selected from the group consisting of tokens with different faces, dice with at least two different faces, and symmetrical outcome displaying objects displaying at least two different outcomes. The method may also be practiced wherein the at least two gaming outcome elements are enclosed within a single display chamber or separate individual chambers so that both physical randomizing orientation of the at least two gaming outcome elements is visually observable by players and results of the actual orientation of the at least two gaming outcome elements can be visually observed by players. The at least two gaming outcome elements may be each enclosed within separate display chambers so that both physical randomizing orientation of the at least two gaming outcome elements is visually observable by players and results of the actual orientation of the at least two gaming outcome elements can be visually observed by players.

The term “physical randomizing orientation” or “random physical reorientation” refers to the fact that the physical game elements are physically moved as by tumbling, tossing, rolling, bouncing, air jetting, air cannons, shakers, shakers and tossers, magnetic tumbling, popping or flipping without specific control being imposed or applied with a non-randomizing intent, such as a single flip, a single bounce, dropping with intent for a specific face to hit flat, etc. The intent is a physical movement of the gaming outcome element that is designed to allow randomness in the gaming event outcome for the element, as opposed to attempting to impose physical control on the gaming outcome element.

The method may use the at least two gaming outcome elements comprise dice or tokens which are enclosed within a single display chamber or separate display chambers so that both physical randomizing orientation of the at least two gaming outcome elements is visually observable by players and results of the actual orientation of the at least two gaming outcome elements can be visually observed by players. Where there are two separate chambers, each separate chamber may have or should have an independent physical reorientation component that physically and randomly reorients each of the at least two gaming outcome elements so that an exposed face of each displays a random outcome.

A system for enabling this type of wagering on an underlying wagering event including:
a processor, memory, player input controls, value-in-value-out system, a visual display area enclosing at least two gaming outcome elements each of which is capable of providing at least two distinct random outcomes;
   the system having a mechanical system capable of physically reorienting the at least two gaming outcome elements;
   a sensing system capable of determining final reoriented outcomes on the at least two gaming outcome elements;
   the processor configured to receive wagers on specific random outcome events provided by the at least two gaming outcome elements compare final reoriented outcomes with the specific random outcome events on which a received wager is based; and
   wherein the at least two gaming outcome elements have equal probability of different outcomes on at least two surfaces and the received wager identifies distinct random outcome events for each of the at least two gaming outcome events. The system may include gaming outcome elements selected from the group consisting of dice and tokens. The system may include wagers on gaming outcomes including at least two tokens with two different faces, and each of the at least two tokens is contained in a separate transparent chamber, and each separate transparent chamber comprises a physical random reorientation system. The wagered-on gaming outcomes comprise at least two dice with at least three different faces, and each of the at least two dice is contained in a separate transparent chamber, and each separate transparent chamber comprises a physical random reorientation system. The system may have the processor configured to receive wagers on at least one specific random outcome event comprising identification of random wagering outcomes for both of the at least two tokens, or wherein the processor is configured to receive wagers on at least one specific random outcome event comprising identification of random wagering outcomes for both of the at least two dice.

The concept of a Dual Coin/Dice/Object flipping game with hold option is further explained below. A gaming apparatus can flip/toss (by mechanical means such as motors, springs, air jets, etc.) two separate physical objects such as coins or dice to create two independent random outcomes. Each object is contained in its own case (such as a cylinder or dome made of a durable transparent material). Each case has a separate mechanism for physically tossing the object with sufficient force to ensure a random and unpredictable outcome every time.

The preferred method for propelling each physical object would be a single jet or a series of jets of compressed air. With each toss of an object, a random pattern of air bursts could be selected by the computer (for example, a strong jet of air followed by two quick puffs of air while the object is in the air). This would further ensure the randomness and unpredictability of the outcome. Each case might contain more than 1 source for air, ensuring that the object could be blasted with a powerful jet of air from different locations in the case to again ensure randomness and unpredictability. Each case would contain a mesh opening on the top to ensure the released air can escape the container. (An alternate method for tossing the objects would be to include a physical platform at the base that would violently shake to disrupt each object).

In addition to a mechanism that propels each object within its contained case separately, sensors would be embedded in each object to detect the outcome of each toss for each object. This sensor could include a chip that communicates the final orientation of the object to a receptor located at the base of each case. Or, alternately, a camera or a pair of cameras could identify the final orientation of each object and relay that information to the computer. Another element of the device would be the touchscreen game screen where players would make their wagers, select their game choices, and activate the launching mechanism(s). (Alternately, one or two physical buttons might be available for players to press to activate the launching mechanism(s).

By launching each object separately in its own separate case, it becomes possible to offer more complex games for players to wager one. For example: a game could consist of two separate coins. The player chooses double heads as his outcome. Both coins are flipped separately. If both coins are tails, the player loses. If both coins are heads, the player wins. If one coin is a head and one coin is a tail, the player could hold the head position coin and flip the tail position coin to try to make it a head.

In a separate example, the player flips two six-sided dice. The player bets on a final total of 10. If at least one of the two die thrown is a 4, 5, or 6, that die can be held and the player can launch the second die in an attempt to make the 10.

This apparatus could be used for real-money gambling, or alternately could be included in arcades where players could flip coins or throw dice (or some other object) to win tokens or tickets to redeem for prizes. An alternate configuration of the device might allow several players to make different bets on the outcome of the tossed objects. A completely electronic virtual variation of the wagering event may be executed on electronic machinery, with or without physical gaming outcome elements.

By launching each object separately in its own separate case, it becomes possible to offer more complex games for players to wager one. For example: a game could consist of two separate coins. The player chooses double heads as his outcome. Both coins are flipped separately. If both coins are tails, the player loses. If both coins are heads, the player wins. If one coin is a head and one coin is a tail, the player could hold the head and flip the tail coin to try to make it a head.

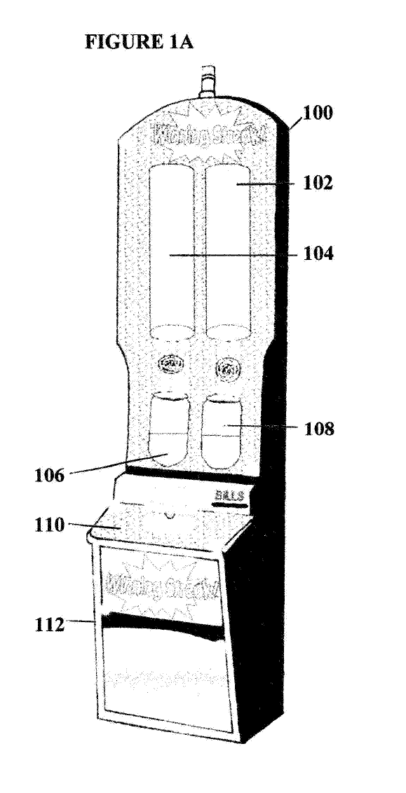

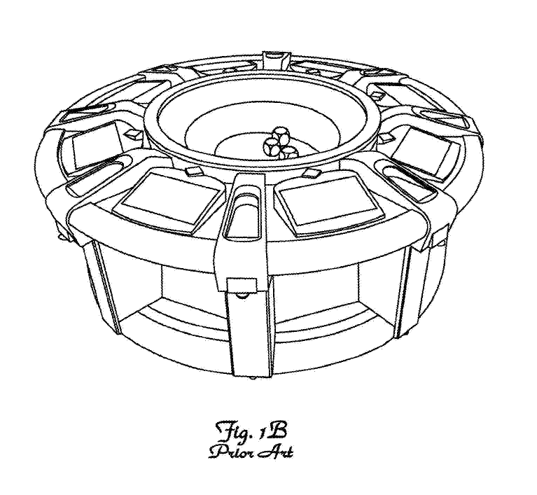

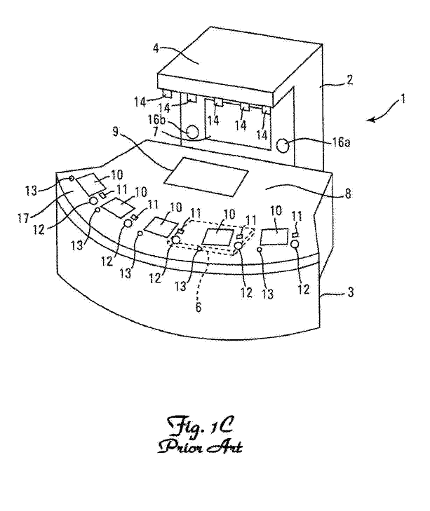

FIG. 1C shows a fully automated gaming table 1 of the prior art, as disclosed in U.S. Patent Application 2003/0199316 and U.S. Pat. No. 7,628,689 which are incorporated herein by reference in their entirety. The system 1 comprises a vertical upright display cabinet 2 and a player bank or station cluster arrangement 3. The vertical display cabinet 2 has a viewing screen 7 on which images of the virtual dealer are displayed. The top 8 of the player bank arrangement 3 has individual monitor screens 10 for each player position, as well as tabletop inserted coin acceptors 11, and player controls 12 and 13. There is a separate and larger game play area for the multiple flipping elements 9 are displayed in a format large enough for all players to view. When two distinct gaming outcome elements are used in this area, they may be provided so that each element may be 8 individually flipped or where both can be flipped (reoriented). When both elements are present in a single chamber, the individual elements should be distinguishable by mechanical or visual automated reading. In this way, the individual elements can be used to provide individual result outcomes. For example, with a red die and a blue die, after a first flip/bounce, each die will have its own unique outcome. If it is desired to reorient (re-flip) only one die, the processor will lock in the outcome for one die, both dice will be flipped, and the new value for the re-flipped die will be used to determine the event outcome, while the locked value remains. By having a reading function (e.g., RFID, transducer, color reader, etc.), the value for the re-flipped second die can be distinguished from the original or non-functional re-flipped value of the first die. Speakers andb are provided for sound transmission and decorative lights may be provided.

The two chamber system of FIG. 1A more easily facilitates a methods wherein the system allows (upon a player input through the player input controls) the processor to be configured such that after the sensing system has determined a first final reoriented outcomes on the at least two gaming outcome elements, the processor is configured to receive instructions to lock in one final reoriented outcome for at least a first one of the at least two gaming outcome elements, direct a second reorientation of at least a second one of the at least two gaming outcome elements, and the sensing system then determining a second final reoriented outcome foe the second one of the at least two gaming outcome elements in combination with the locked in one final reoriented outcome for at least a first one of the at least two gaming outcome elements. By having the separate chambers, the second reorientation of a single gaming outcome element can be more easily facilitated.

FIG. 1A shows a gaming cabinet 100, an right-side chamber 102 for a first gaming outcome element (not shown), a left-side chamber 104 for a second gaming outcome element (not shown), a right-side final reorientation position chamber 108 for displaying a final resting position for a first gaming outcome element (not shown), a left-side final reorientation position chamber 106 for displaying a final resting position for a second gaming outcome element (not shown), a player input control panel 110 and a base 112. The player input control panel 110 may have the popper shown, touchscreen (not shown) and/or button arrays (not shown).

### Computer-Based Implementations

Methods of the present invention may be implemented in computer hardware, software, or computer hardware and software. A most common form of computer implementation is a stand-alone, single player electronic gaming machine with electronic player controls and one or more video output screens.

In computer-based embodiments, the gaming device preferably includes at least one processor, such as a microprocessor, a microcontroller-based platform, a suitable integrated circuit or one or more application-specific integrated circuits (ASIC's) or Field Programmable Gated Arrays (FPGA's). The processor is in communication with or operable to access or to exchange signals with at least one data storage or memory device, and/or a player monitor or monitors. In one embodiment, the processor and the memory device reside within the cabinet of a gaming device. Multiple gaming devices are typically connected to a casino information network.

The memory device stores program code and instructions, executable by the processor, to control the gaming device. The memory device also stores other data such as image data, event data, player input data, random or pseudo-random number generators, pay-table data or information, House Ways distributions and applicable game rules that relate to the play of the gaming device. In one embodiment, the memory device includes random access memory (RAM): which can include non-volatile RAM (NVRAM): magnetic RAM (MRAM), ferroelectric RAM (FeRAM), and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical, and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD, or USB memory device.

In other embodiments, part or all of the program code and/or operating data described above can be downloaded to the memory device through a suitable network. In one embodiment, an operator or a player can use such a removable memory device in a desktop computer, a laptop computer, a personal digital assistant (PDA), a portable computing device, or another computerized platform to implement the present disclosure. In one embodiment, the gaming device or gaming machine disclosed herein is operable over a wireless network, for example part of a wireless gaming system. The gaming machine may be a hand-held device, a mobile device, or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “processor” or “computer” or “controller” or “game controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator, or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome. It is also possible for templates or weighted templates of sets of tiles or paylines as disclosed in U.S. Pat. Nos. 6,159,096 and 6,117,009 (Yoseloff, which are incorporated by reference in their entirety) which disclose a method of configuring a video output gaming device to randomly generate game outcomes. The method includes the steps of selecting a set of game symbols, assigning a probability of occurrence to each symbol, selecting a plurality of outcome templates, each template comprising X variables, selecting a probability of occurrence for each outcome template, assigning a subset of symbols from the set of game symbols to each template for filling the positions, defining payouts for selected outcomes, and configuring a video output gaming device, which randomly selects a template, randomly selects a symbol for each variable in the template from the subset of game symbols assigned to the selected template, randomly fills at least a portion of the positions in the template and displays the outcome on a video output display. A video output gaming device programmed to randomly select a template, randomly select symbols to define the variables and randomly display the selected symbols is also disclosed.

In one embodiment, described in more detail below as a “chipless gaming platform”, the gaming device includes one or more display devices that are mounted into a gaming table surface and are controlled by the processor in addition to or separately from the individual player monitors. The display devices are preferably connected to or mounted into the table structure. This may include a central display device which displays a primary game, dealer images, jackpot information, or information that is not specifically related to the game, such as sports information or winning events at other tables. This display device may also display any suitable secondary game associated with the primary game as well as information relating to the primary or secondary game (e.g., side bets, bonuses, jackpots and the like).

An alternative embodiment may include a central horizontal game display device and a vertically oriented virtual dealer display device as in Shuffle Master, Inc.'s Table Master™ gaming system. The central display device may display the primary game, any suitable secondary game associated or not associated with the primary game and/or information relating to the primary or secondary game. These display devices may also serve as digital glass operable to advertise games or other aspects of the gaming establishment. The gaming device includes a credit display 20 which displays a player's current number of credits, cash, account balance, or the equivalent. In one embodiment, the gaming device includes a bet display displays a player's amount wagered. In one embodiment, as described in more detail below, the gaming device includes a player tracking display which displays information regarding a player's play tracking status.

In yet another embodiment, at least one display device may be a mobile display device, such as a PDA or tablet PC that enables play of at least a portion of the primary or secondary game at a location remote from the gaming device. The display devices may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism.

In one embodiment, as described in more detail below, the display device includes a touch-screen with an associated touch-screen controller. The display devices may be of any suitable size and configuration, such as a square, a rectangle or an elongated rectangle. The display devices of the gaming device are configured to display at least one and preferably a plurality of game or other suitable images, symbols and indicia such as any visual representation or exhibition of the movement of objects such as mechanical, virtual, or video reels and wheels, dynamic lighting, video images, images of people, characters, places, things, faces of cards, images of dealers and the like.

Other forms of the invention are in the form of game software that is implemented in a variety of formats, such as internet gaming, PC practice play, hand-held game devices, wireless gaming devices and the like.

### Chipless Gaming Table Implementation

One enabling system useful in the practice of the present invention is the use of playing cards with Chinese domino symbols which can be distributed for use with a system marketed under the name i-TABLE™ by Shuffle Master, Inc. of Las Vegas, Nev. That system includes: a) a physical gaming table; b) player monitors at each player position; c) a playing card reading and delivery system (e.g., commercially available shufflers and playing card delivery shoes with reading capability as sold under the Trade names of One2Six™ shuffler, Ace™ shuffler, I-DEAL™ shuffler, I-SHOE™ delivery shoe, etc.); d) a processor receiving information (numbers of cards, rank of cards, suits of cards, etc.) from the card reading and delivery systems; e) communication connectivity (hardwired or wireless) between necessary combinations of the card reading/delivery systems and the processor, the processor and the individual player monitors, and/or the card reading/delivery systems and the video monitors; and f) software in the processor that defines predetermined advantage for distributions of playing cards into multiple hands, game rules, hand history, and the like.

With regard to software f), it is understood in the practice of the present technology that this is not complex software that reads individual player hand cards and determines advantageous card distributions for a first time by extensive calculations. Rather, the entire range of possibilities of hands (e.g., all possible five card sets dealt to players in poker-style games) is known in poker style games.

A preferable card handling device for administering a video reel-type-style game is a hand-forming shuffler with integrated card recognition technology, from which playing cards are supplied, with a least a rank/count (and preferable also suit) of individual packs of cards are known before the cards are removed and delivered to player positions and/or the banker position. The card delivery system 102 is in communication with the controller 128 by wired or wireless communication methods. Communication between the various system components is not limited to electronic or electrical signals, but may include optical signals, audio signals, magnetic transmission or the like.

The individual player position processors (not shown) are preferable graphics processors and not full content CPUs as a cost saving, space saving, and efficiency benefit. With the reduced capacity in the processor as compared to a CPU, there is actually reduced likelihood of tampering and fraudulent input.

A video gaming machine may contain a main cabinet, which generally surrounds the machine interior (not shown) and is viewable by users. The main cabinet includes a main door on the front of the machine, which opens to provide access to the interior of the machine. Attached to the main door are player-input switches or buttons, a coin acceptor, and a bill validator, a coin tray, and a display area including a mechanical gaming system (or less preferably a separate electronic game). There may be an overlay of touchscreen functionality on the separate electronic game or some of the buttons may be functional on the separate mechanical gaming system. That separate mechanical gaming system may be in a relatively vertical viewing position as shown, or in a more horizontal (table like) display unit. Viewable through the main door is a video display monitor 34 and an information panel. The display monitor will typically be a cathode ray tube, high resolution flat-panel LCD, LED, plasma screen or other conventional electronically controlled video monitor. The information panel may be a back-lit, silk screened glass panel with lettering to indicate general game information including, for example, a game denomination (e.g. $0.25 or $1). The bill validator player-input switches, video display monitor, and information panel are devices used to play a game on the game machine. The devices are controlled by circuitry (e.g. the master gaming controller) housed inside the main cabinet of the machine.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine may include a top box with one or more reorienting chambers, which on top of the main cabinet. The top box houses a number of devices, which may be used to add features to a game being played on the gaming machine, including speakers, a ticket printer which prints bar-coded tickets, a key pad for entering player tracking information, a florescent display for displaying player tracking information, a card reader for entering a magnetic striped card containing player tracking information, and a video display screen. The ticket printer may be used to print tickets for a cashless ticketing system. Further, the top box may house different or additional devices than elsewhere shown. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet of the machine.

FIG. 1C shows an example of an automated table system 1 useful to practice the game play methods of the present invention. This system is fully disclosed in U.S. Patent Publication 2005/0164759 A1. The content of this application is incorporated by reference in its entirety. The system 1 has an upright dealer display cabinet 2 with a top 4 and a virtual dealer viewing screen 7 which may be any form of display screen such as a CRT, plasma screen, liquid crystal screen, LED screen or the like. The common player area has a common player display are with a top 9 through which the reorienting game outcome elements (not shown) are viewable. Touch screen player input controls 10 are located. Other player input functions may be provided on a panel 11 which might accept currency, coins, tokens, identification cards, player tracking cards, ticket in/ticket out acceptance, and the like. Additional player buttons 13, speakers 16a and special player information displays 14 are also shown.

Understand that gaming machine is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gam ng logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaining machines Operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of JOT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of a stand-alone video gaming apparatus, when a user wishes to play the gaming machine, he or she inserts cash through the coin acceptor or bill validator or ticket-in-ticket-out systems or a credit card reader, all being value-in-value-out-systems. Additionally, the bill validator may accept a printed ticket voucher which may be accepted by the bill validator as an indicia of credit when a cashless ticketing system is used. At the start of the game, the player may enter playing tracking information using the card reader, the keypad, and the florescent display. Further, other game preferences of the player playing the game may be read from a card inserted into the card reader. During the game, the player views game information using the video display. Other game and prize information may also be displayed in the video display screen located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches, the video display screen or using some other device which enables a player to input information into the gaming machine. In some embodiments, the player may be able to access various game services such as concierge services and entertainment content services using the video display screen and one more input devices.

During certain game events, the gaming machine may display visual and auditory effects that can be perceived by the player. These effects add to the excitement of a game, which makes a player more likely to continue playing. Auditory effects include various sounds that are projected by the speakers. Visual effects include flashing lights, strobing lights or other patterns displayed from lights on the gaming machine or from lights within the separate mechanical (or electronic) separately, individually wagerable gaming system. After the player has completed a game, the player may receive game tokens from the coin tray or the ticket from the printer, which may be used for further games or to redeem a prize. Further, the player may receive a ticket for food, merchandise, or games from the printer.

Another gaming network that may be used to implement some aspects of the invention is where a gaming establishment could be any sort of gaming establishment, such as a casino, a card room, an airport, a store, etc. In this example, gaming network includes more than one gaming establishment, all of which are networked to game server.

Here, gaming machine, and the other gaming machines and, include a main cabinet and a top box. The main cabinet 1006 houses the main gaming elements and can also house peripheral systems, such as those that utilize dedicated gaming networks. The top box 1004 may also be used to house these peripheral systems.

The master gaming controller controls the game play on the gaming machine according to instructions and/or game data from game server or stored within gaming machine and receives or sends data to various input/output devices on the gaming machine. In one embodiment, master gaming controller includes processor(s) and other apparatus of the gaming machines described above. The master gaming controller 1008 may also communicate with a display.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with an EFT system, EZPay™ system, and player tracking system. The systems of the gaming machine communicate the data onto the network via a communication board.

It will be appreciated by those of skill in the art that embodiments of the present invention could be implemented on a network with more or fewer elements than are elsewhere discussed. For example, player tracking system is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU and translator are not required for all gaming establishments. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller provides this function for gaming establishment. Site controller is connected to a central system and/or other gaming establishments via one or more networks, which may be public or private networks. Among other things, site controller communicates with game server to obtain game data, such as ball drop data, bingo card data, etc.

In the present illustration, gaming machines may be connected to a dedicated gaming network. In general, the DCU functions as an intermediary between the different gaming machines on the network and the site controller. In general, the DCU receives data transmitted from the gaming machines and sends the data to the site controller over a transmission path. In some instances, when the hardware interface used by the gaming machine is not compatible with site controller, a translator may be used to convert serial data from the DCU to a format accepted by site controller. The translator may provide this conversion service to a plurality of DCUs.

Further, in some dedicated gaming networks, the DCU can receive data transmitted from site controller for communication to the gaming machines on the gaming network. The received data may be, for example, communicated synchronously to the gaming machines on the gaming network.

Here, CVT provides cashless and cashout gaming services to the gaming machines in gaming establishment. Broadly speaking, CVT authorizes and validates cashless gaming machine instruments (also referred to herein as “tickets” or “vouchers”), including but not limited to tickets for causing a gaming machine to display a game result and cash-out tickets. Moreover, CVT authorizes the exchange of a cashout ticket for cash. These processes will be described in detail below. In one example, when a player attempts to redeem a cash-out ticket for cash at a cashout kiosk, cash out kiosk reads validation data from the cashout ticket and transmits the validation data to CVT for validation. The tickets may be printed by gaming machines, by cashout kiosk, by a stand-alone printer, by CVT, etc. Some gaming establishments will not have a cashout kiosk. Instead, a cashout ticket could be redeemed for cash by a cashier (e.g. of a convenience store), by a gaming machine or by a specially configured CVT.

An example of a network device that may be configured for implementing some methods of the present invention. Network device includes a master central processing unit (CPU), interfaces, and a bus (e.g., a PCI bus). Generally, interfaces include ports appropriate for communication with the appropriate media. In some embodiments, one or more of interfaces includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces control such communications-intensive tasks as encryption, decryption, compression, decompression, packetization, media control and management. By providing separate processors for the communications-intensive tasks, interfaces allow the master microprocessor efficiently to perform other functions such as routing computations, network diagnostics, security functions, etc.

The interfaces are typically provided as interface cards (sometimes referred to as “linecards”). Generally, interfaces control the sending and receiving of data packets over the network and sometimes support other peripherals used with the network device. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU may be responsible for implementing specific functions associated with the functions of a desired network device. According to some embodiments, CPU accomplishes all these functions under the control of software including an operating system and any appropriate applications software.

CPU may include one or more processors such as a processor from the Motorola family of microprocessors or the MIPS family of microprocessors. In an alternative embodiment, processor is specially designed hardware for controlling the operations of network device. In a specific embodiment, a memory (such as non-volatile RAM and/or ROM) also forms part of CPU. However, there are many different ways in which memory could be coupled to the system. Memory block may be used for a variety of purposes such as, for example, caching and/or storing data, programming instructions, etc.

Regardless of network device's configuration, it may employ one or more memories or memory modules (such as, for example, memory block) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention also relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

While this invention is described in terms of preferred embodiments, there are alterations, permutations, and equivalents that fall within the scope of the invention. It should also be noted that there are many alternative ways of implementing the present invention. It is therefore intended that the invention not be limited to the preferred embodiments described herein, but instead that the invention should be interpreted as including all such alterations, permutations, and equivalents as fall within the true spirit and scope of the present invention.

What is claimed:

1. A method for executing a wagering event on an electronic gaming apparatus comprising a housing, a processor, memory, a display area for providing wagering event outcomes with gaming outcome elements, player input controls, and value-in-value-out components, the method comprising:
providing at least two visually different gaming outcome elements within a confined area in a gaming apparatus;
the processor accepting a wager on an underlying gaming event executed on the electronic gaming apparatus based on random event outcomes using the gaming outcome elements;
physically randomizing orientation of the at least two gaming outcome elements to provide two distinct wagering event outcomes, one each on each of the at least two gaming outcome elements;
the processor receiving information on the actual orientation of the at least two gaming outcome elements which provides two distinct wagering event outcomes; and
the processor resolving the wager on the underlying gaming event as follows;
c) the wager on the underlying gaming event is based on correspondence on predicted gaming event outcomes on each of the at least two gaming outcome elements with the received information of the actual orientation of the at least two gaming outcome elements; and
d) winning outcomes are determined based on correspondence on event outcomes having probabilities no greater than 1:2.

2. The method of claim 1 wherein the at least two gaming outcome elements comprise physical elements with at least two surfaces having equal opportunities for gaming event outcomes.

3. The method of claim 2 wherein the at least two gaming outcome elements comprise physical elements are selected from the group consisting of tokens with different faces, dice with at least two different faces, and symmetrical outcome displaying objects displaying at least two different outcomes.

4. The method of claim 2 wherein the at least two gaming outcome elements are enclosed within a display chamber so that both physical randomizing orientation of the at least two gaming outcome elements is visually observable by players and results of the actual orientation of the at least two gaming outcome elements can be visually observed by players.

5. The method of claim 2 wherein the at least two gaming outcome elements are each enclosed within separate display chambers so that both physical randomizing orientation of the at least two gaming outcome elements is visually observable by players and results of the actual orientation of the at least two gaming outcome elements can be visually observed by players.

6. The method of claim 2 wherein the at least two gaming outcome elements comprise dice or tokens which are enclosed within a display chamber so that both physical randomizing orientation of the at least two gaming outcome elements is visually observable by players and results of the actual orientation of the at least two gaming outcome elements can be visually observed by players.

7. The method of claim 2 wherein the at least two gaming outcome elements comprise dice or tokens which are each enclosed within separate display chambers so that both physical randomizing orientation of the at least two gaming outcome elements is visually observable by players and results of the actual orientation of the at least two gaming outcome elements can be visually observed by players.

8. The method of claim 5 wherein each separate chamber has independent physical reorientation component that physically and randomly reorients each of the at least two gaming outcome elements.

9. The method of claim 7 wherein each separate chamber has independent physical reorientation component that physically and randomly reorients each of the at least two gaming outcome elements.

10. The method of claim 8 wherein the individual physical reorientation component is selected from the group consisting of an air jet, popper, shaker or flipper.

11. The method of claim 9 wherein the individual physical reorientation component is selected from the group consisting of an air jet, popper, shaker or flipper.

12. A system for enabling wagering on an underlying wagering event comprising:
a processor, memory, player input controls, value-in-value-out system, a visual display area enclosing at least two gaming outcome elements each of which is capable of providing at least two distinct random outcomes;
the system having a mechanical system capable of physically reorienting the at least two gaming outcome elements;
a sensing system capable of determining final reoriented outcomes on the at least two gaming outcome elements;
the processor configured to receive wagers on specific random outcome events provided by the at least two gaming outcome elements compare final reoriented outcomes with the specific random outcome events on which a received wager is based; and
wherein the at least two gaming outcome elements have equal probability of different outcomes on at least two surfaces and the received wager identifies distinct random outcome events for each of the at least two gaming outcome events.

13. The system of claim 12 wherein gaming outcome elements are selected from the group consisting of dice and tokens.

14. The system of claim 12 wherein the gaming outcomes comprise at least two tokens with two different faces, and each of the at least two tokens is contained in a separate transparent chamber, and each separate transparent chamber comprises a physical random reorientation system.

15. The system of claim 12 wherein the gaming outcomes comprise at least two dice with at least three different faces, and each of the at least two dice is contained in a separate transparent chamber, and each separate transparent chamber comprises a physical random reorientation system.

16. The system of claim 14 wherein the processor is configured to receive wagers on at least one specific random outcome event comprising identification of random wagering outcomes for both of the at least two tokens.

17. The system of claim 15 wherein the processor is configured to receive wagers on at least one specific random outcome event comprising identification of random wagering outcomes for both of the at least two dice.
